(19) United States
(12) Patent Application Publication
(10) Pub. No.: US 2004/0231211 A1
(43) Pub. Date: Nov. 25, 2004

(54) Three-dimensional automobile badge

(76) Inventor: John R. Johnson, Valparaiso, IN (US)

Correspondence Address: Cynthia S. Murphy, Renner, Otto, Boisselle & Sklar, LLP, Nineteenth Floor, 1621 Euclid Avenue, Cleveland, OH, 44115-2191, US

(21) Appl. No.: 10/836,737

(22) Filed: Apr. 30, 2004

Related U.S. Application Data
(60) Provisional application No. 60/467,496, filed on May 2, 2003.

(51) Int. Cl. G09F 7/12

(52) U.S. Cl. 40/594

(57) ABSTRACT

A badge comprising a badge portion having a shaped laminate and a structural base. The shaped laminate has an upper surface, providing the viewable surface of the badge portion, and a bottom surface, forming a cavity. The structural base fills the cavity, and its bottom surface at least partially forms the bottom surface of the badge portion. The structural base is formed by pouring an elastomer into the shaped laminate.

### RELATED APPLICATION

This application claims priority under 35 U.S.C. § 119 (e) to U.S. Provisional Application No. 60/467,496 filed on May 2, 2003. The entire disclosure of this provisional application is hereby incorporated by reference.

### FIELD OF THE INVENTION

This invention relates generally, as indicated, to a three-dimensional automobile badge and, more particularly, to a three-dimensional badge that is secured to an automobile via a pressure-sensitive adhesive.

### BACKGROUND OF THE INVENTION

In the automobile industry, the use of badges (i.e., emblems, trademarks, trade names, insignia, logos, designs or the like) has become a common way to decorate and mark a vehicle. Newly manufactured vehicles almost always include exteriorly mounted badges (e.g., on doors, bumpers, panels, or the hood) and/or interiorly mounted badges (e.g., on the dashboard or airbag covers). Three-dimensional badge designs are increasingly popular, as the raised indicia enhances aesthetic appeal overall.

A three-dimensional badge can be made by first providing a flat laminate having the desired color qualities of the badge. The selected flat laminate can be formed (e.g., thermoformed) into the desired three-dimensional design. For example, if the badge is to include raised characters (e.g., letters, symbols, etc.), these will project from the previously flat laminate. As another example, if the badge is to resemble a crest, the badge will take on a dome-like shape.

In either or any case, the so-shaped laminate will have a top surface, providing the viewable portion of the badge, and a bottom surface. The shaped laminate then will be placed in a geometrically compatible mold, and a suitable thermoplastic elastomer can be injected adjacent to the laminate's bottom surface. More specifically, the mold can comprise a lower portion, having a contour adapted to receive the top surface of the shaped laminate, and an upper mating portion, having a contour mimicking that of the bottom surface of the shaped laminate. The upper portion is positioned adjacent to the laminate's bottom surface so that a gap of substantially uniform thickness is formed therebetween. When the elastomer is injected into the gap, it will form a structural carrier for the badge, this carrier having a geometry closely following the bottom contour of the shaped laminate. Accordingly, different molds and/or mold portions are required to manufacture different badges.

### SUMMARY OF THE INVENTION

The present invention provides a three-dimensional automobile badge, which does not require an injection molding step to form the badge's structural member. Instead, the structural member, specifically a structural base, is formed by pouring a suitable thermoplastic into the laminate's cavity. In this manner, the need for different injection molds for production of different badges is eliminated, thereby economizing badge-manufacturing procedures.

More particularly, the present invention provides a three-dimensional automobile badge, comprising a shaped laminate and a structural base for the laminate. The laminate is made from material having the desired color qualities of the badge and is shaped into a desired three-dimensional form, having a top surface and a bottom surface. The top surface forms the viewable portion of the badge, and the bottom surface forms a cavity. The structural base is formed by pouring a suitable elastomer into the cavity.

A further advantage of the present invention is that the pouring step results in the back surface of the badge having a profile that accommodates the efficient application of a layer of pressure-sensitive adhesive. Specifically, if the shaped laminate is positioned in a level manner when the elastomer is poured into the cavity, the elastomer will distribute so that its outermost surface will run smoothly (e.g., flat) between the lateral edges of the shaped laminate. This smooth, flat profile provides an excellent application surface for an adhesive layer and a superior geometry for adhesively securing the badge to the automobile.

These and other features of the invention are fully described and particularly pointed out in the claims. The following description and drawings set forth in detail certain illustrative embodiments of the invention, which are indicative of but a few of the various ways in which the principles of the invention may be employed.

### DRAWINGS

FIG. 1 is a schematic view of a three-dimensional badge according to the present invention secured to an automobile.

FIG. 2 is a perspective view of the badge prior to being secured to the automobile.

FIG. 3 is a sectional view of the badge with its release liner removed.

FIGS. 4A-4G are schematic views of a method of making the three-dimensional badge according to the present invention.

### DETAILED DESCRIPTION

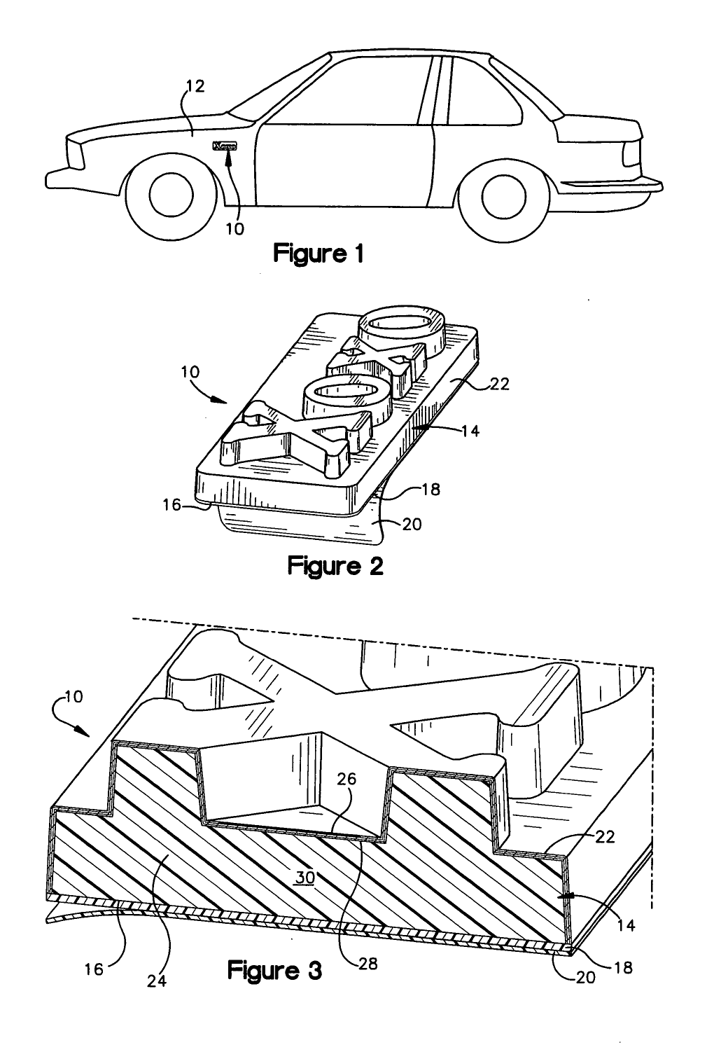

Referring now to the drawings, and initially to FIG. 1, a three-dimensional badge 10 according to the present invention is shown secured to an automobile 12. The badge 10 is shown secured to the exterior of the automobile 12 and, more particularly, to its door panel. Also, the illustrated badge 10 includes the raised letters “XOXO” (which could denote, for example, the automobile manufacturer's emblem, trademark, trade name, insignia, logo, design or the like) and has a generally rectangular shape, with the raised letters projecting therefrom. However, other attachment locations (both interior and exterior) and/or badge geometries are possible with, and contemplated by, the present invention.

Referring now to FIGS. 2 and 3, the badge 10 is shown prior to being secured to the automobile 12. The badge 10 has an upper badge portion 14 with a bottom surface 16, an adhesive layer 18 positioned adjacent to the bottom surface 16, and a release liner 20 positioned adjacent to the adhesive layer 18.

As is best seen in FIG. 3, the badge portion 14 comprises a shaped laminate 22 and a structural base 24. The shaped laminate 22 has an upper surface 26, providing the viewable surface of the badge portion 14, and a bottom surface 28, forming a cavity 30. The structural base 24 fills the cavity 30, and its bottom surface, together with the bottom-most edges of the shaped laminate 22, forms the bottom surface 16 of the badge portion 14.

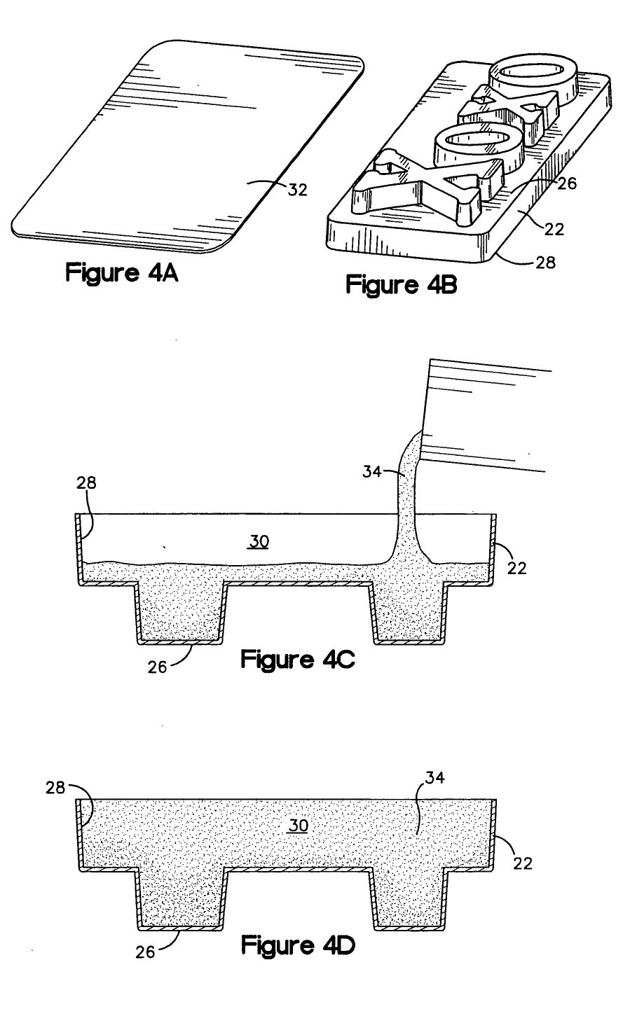

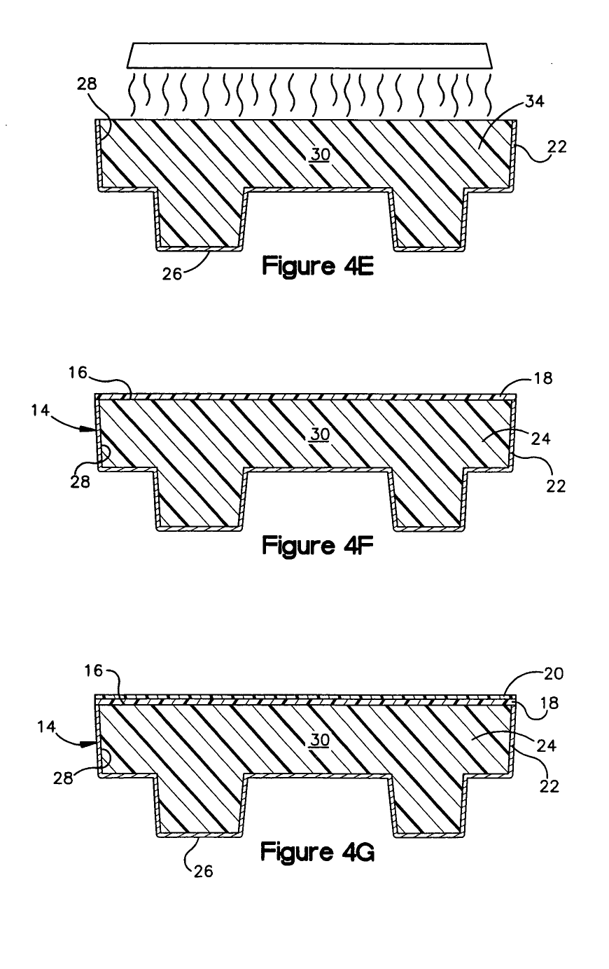

Referring now to FIGS. 4A-4G, a method of making the badge 10 according to the present invention is schematically shown. Initially, a flat laminate 32 is provided having the desired color and other appearance qualities of the badge 10. (FIG. 4A.) The flat laminate 32 then is thermoformed to form the three-dimensional shaped laminate 22. (FIG. 4B.) A suitable elastomer 34 then is poured into the cavity 30 until it completely fills the cavity 30. (FIGS. 4C and 4D.) The poured elastomer 34 then is cured to form the structural base 24 and the bottom surface 16 of the badge portion 14 (FIG. 4E), and the adhesive layer 18 and release liner 20 can be positioned thereon (FIG. 4F and 4G).

Significantly, the pouring of the elastomer 34 results in the bottom surface 16 having a smooth, flat profile extending across the entire badge-to-automobile attachment area. This profile is accomplished through gravity, and formation thereof does not require any specially designed injection molding equipment. Instead, the shaped laminate 22 simply is mounted in a level manner during the pouring and curing steps. Such a level-mounting arrangement can be achieved with a low-cost device and can be designed to accommodate a wide range of badge sizes or shapes. Additionally or alternatively, the bottom surface 16 provides an excellent surface for the adhesive layer 18, as simple coating techniques can be used to achieve uniform distribution and/or the non-profiled adhesive area can improve badge-to-automobile adhesion.

When a color is desired for the badge, the laminate 32 can be composed of a backing sheet (e.g., thermoplastic polyolefin, acrylonitrile-butadiene-styrene, and/or polycarbonate), a color coat (e.g., acrylic or polyvinylidene difluoride (PVDF)), and a clear coat (e.g., acrylic or polyvinylidene difluoride (PVDF)) to provide film elasticity, chemical resistance, stain resistance, weathering and/or UV protection. If necessary or desired, one or more tie coats can be provided between the backing sheet and the color coat. A suitable product is sold by Avery Dennison Corporation (the assignee of this application) under the registered trademark AVLOY.

When a chrome-like appearance is desired, the laminate 32 can comprise alternatively a baseweb layer, a metal layer, and an optically clear polymeric outer layer. The base-web layer comprises a flexible thermoplastic and thermoformable polyurethane film. The metal layer comprises indium or an alloy of indium and is applied to the surface of the baseweb by vapor deposition techniques. The optically clear polymeric outer layer preferably contains an acrylic or polycarbonate resin and is laminated to the exposed surface of the metalized film in free-film form and under heat and pressure. The lamination step not only bonds the outer layer of the metal layer but also enhances reflectivity of the metal. The polyurethane baseweb promotes adhesion of the metal layer to the baseweb in the absence of an intervening bonding layer or surface treatment, while lamination smooths out the metal layer to a mirror-like finish that produces a reflective laminate having a distinctness-of-image (reflectivity) over 95. The laminate can (and may be necessary when the outer layer is polycarbonate) further include an over-laminate comprising a film of polyvinylidene fluoride and acrylic resin alloy bonded to the outer layer. The laminate can be thermoformed to a three-dimensional shape while retaining its high level of distinctness-of-image. Additional details regarding this laminate can be found in concurrently filed U.S. patent application (Ser. No. 10/429,015; inventor John Richard Johnson) entitled BRIGHT FORMABLE METALIZED FILM LAMINATE. (This application is assigned to the assignee of the present application, and its entire disclosure hereby is incorporated by reference.)

The laminate 32 instead can comprise a polymeric face sheet and an electrically conductive thermoformable polymeric primer coat (including a dry paint transfer film) bonded to an exterior surface of the polymeric face sheet. With such a laminate, the conductive dry paint transfer film can comprise a thermoplastically-formable polymeric material containing a dispersed conductive material that provides electrical conductivity to an exposed surface of the film. In this manner, the laminate 32 will be suited especially for situations where electrostatic spray painting of the badge is desired in order to, for example, match the color of the automobile 12. Further details of such laminates, polymeric face sheets, primer coats, and electrostatic spray painting are set forth in U.S. Pat. Nos. 5,490,893 and 5,686,186. (These two patents are assigned to the assignee of the present invention, and their entire disclosures hereby are incorporated by reference.)

The thermoforming step can be performed using conventional thermoforming technology (e.g., vacuum, pressure or mechanical forces). For example, the laminate 32 can be placed in a clamping frame and moved along a track into an oven for heating to an appropriate thermoforming temperature. The appropriate thermoforming temperature may vary for different laminates, but will usually lie between 250° and 480° (these temperatures are actual laminate temperatures, not oven temperatures). A pressure assist can be used during the thermoforming step in order to reduce the required thermoforming temperature. In any event, the laminate 32 may sag somewhat upon reaching its thermoforming state.

After the laminate 32 is heated to the desired temperature, the clamping frame can be moved back along the track, away from the oven, and to a position above a vacuum-forming buck. The working surface of the vacuum-forming buck will correspond to the desired three-dimensional shape of the badge portion 14. The preheated laminate next is vacuum-formed into the desired three-dimensional shape. Specifically, a vacuum is drawn through the vacuum-forming buck (through its connection to a vacuum pump), the buck is moved into contact with the bottom surface of the laminate 32, and the vacuum is pulled through holes in the buck to force the hot plastic into the shape of the working surface of the buck. Positive air pressure can be applied to the opposite (top) surface of the laminate to increase forming pressure. The buck stays in place long enough to cool the plastic to a solid state again before retracting. This leaves behind the plastic in the shape of the buck.

In alternate possible thermoforming steps (not shown), the laminate can be fed to the thermoformer as a continuous sheet. The laminate first passes through the oven and then passes to the thermoforming buck in line with the downstream end of the oven. The continuous sheet is stopped at preset intervals for heating the laminate to the thermoforming temperature while a previously heated portion of the sheet is vacuum formed into the desired shape.

In the illustrated and/or above-discussed thermoforming steps, a male vacuum former (i.e., the buck) is used and directly contacts the bottom surface of the laminate 32. This prevents the former from contacting the upper surface of the laminate 32, which will constitute the upper surface 26 of the shaped laminate and, eventually, the visible surface of the badge 10. This may be especially advantageous if the upper surface 26 has a conductive coating or other type of finish that would be susceptible to mold-imposed damage. That being said, female molds also can be used successfully. Also, while thermoforming is preferred, other types of forming methods (e.g., stamping, cold-pressing, etc.) are possible with and contemplated by the present invention.

The elastomer 34 (and/or the structural base 24) preferably is a thermoplastic elastomer such as a thermoplastic polyolefin, thermoplastic urethane, polyurethane, polyester, polycarbonate, a mixture of polycarbonate and ABS (acrylonitrile/butadiene-e/styrene) or similar material. In the case of urethanes, any suitable formulation is acceptable, including the incorporation or utilization of various fillers, catalysts, additives, and surfactants. However, no particular limitation is imposed on the elastomer 34, except that it must be transformable into a pourable condition and curable into a solid condition. To this end, the elastomer 34 could be comprised of gel-like organic materials (e.g., silicone gels, acrylic resin gels, fluorinated resin gels), rubber-like organic materials (e.g., silicone rubbers, urethane rubbers, fluorinated rubbers, acrylic rubbers, ethylene-acrylic rubbers, SBR, BR, NBR, chloroprene rubbers), flexible curable resins (e.g., epoxy resins, ultraviolet-curing resins, silicone resins), and flexible thermoplastic resins (e.g., polyvinyl acetate, poly vinyl chloride, acrylic resins such as polyethyl methacrylate, polyvinylidene chloride resin, polyvinyl butyral resins, and polyamide resins).

The elastomer 34 can be stored in a suitable container at appropriate temperature and pressure conditions and, if necessary, mixing can be performed continuously or periodically to maintain the desired viscosity. Preferably, the storage container allows pouring of the elastomer 34 therefrom. Depending upon the constitution of the elastomer 34, the curing step can be traditional thermal curing, ultraviolet curing, and/or electron beam curing. In fact, in many instances the elastomer 34 may be curable at ambient temperatures but this will, of course, take longer. If necessary, desired, or convenient, the shaped laminate 22 can remain in the forming buck (or other analogous forming device) during the pouring and/or curing steps.

The adhesive layer 18 is a preferably pressure-sensitive adhesive and can be any of a number of commercially available adhesives such as, for example, an acrylic pressure-sensitive adhesive. More particularly, for example, the (non-bakeable) pressure-sensitive, translucent, solid core, acrylic tape system marketed by ADCO Global Inc. under the product designation AT-3 may be used. The release liner 20 preferably is coated with a release material such as silicone-based polymer, which permits ready removal when it is desired to adhere the badge portion 14 to the automobile 12.

It may be noted that the badge 10 further could include a pre-mask to protect the viewable surface 26 during application of the badge 10 to the automobile 12. Such a pre-mask can be composed of polyethylene or polypropylene, with a thin coating of adhesive lightly tacked to the surface 26. The pre-mask is removed after the adhesive side of the badge 10 has been pressed onto the mounting surface, whereby more pressure can be applied without scratching the surface 26.

Although the invention has been shown in connection with a badge 10 for an automobile 12, this badge construction and/or badge manufacturing technique can be useful in non-automobile industries. For example, home appliances often have similar badges or emblems. Also, the invention might find application in the making of novelty items, such as key rings and souvenirs.

Although the invention has been shown and described with respect to certain preferred embodiments, it is obvious that equivalent and obvious alterations and modifications will occur to others skilled in the art upon the reading and understanding of this specification. The present invention includes all such alterations and modifications and is limited only by the scope of the following claims.

1. A badge comprising a badge portion having a shaped laminate and a structural base wherein:
the shaped laminate has an upper surface, providing the viewable surface of the badge portion, and a bottom surface, forming a cavity;
the structural base fills the cavity, and its bottom surface at least partially forms the bottom surface of the badge portion; and
wherein the structural base is formed by pouring an elastomer into the shaped laminate.

2. A badge as set forth in claim 1, wherein the shaped laminate is thermoformed.

3. A badge as set forth in claim 1, further comprising an adhesive layer positioned adjacent to the bottom surface.

4. A badge as set forth in claim 3, wherein the adhesive layer comprises a pressure-sensitive adhesive.

5. A badge as set forth in claim 4, wherein the adhesive layer comprises an acrylic pressure-sensitive adhesive.

6. A badge as set forth in claim 4, wherein a release liner is positioned adjacent to the adhesive layer.

7. A badge as set forth in claim 6, wherein the release liner comprises a silicone-based polymer.

8. A badge as set forth in claim 1, wherein the bottom surface has a smooth, flat profile extending across the perimeter of the shaped laminate.

9. A badge as set forth in claim 1, wherein the shaped laminate comprises a backing sheet, a color coat, and a clear coat.

10. A badge as set forth in claim 9, wherein the backing sheet is thermoplastic polyolefin, acrylonitrile-butadiene-styrene, and/or polycarbonate.

11. A badge as set forth in claim 9, wherein the color coat is acrylic or polyvinylidene difluoride (PVDF).

12. A badge as set forth in claim 9, wherein the clear coat is acrylic or polyvinylidene difluoride (PVDF).

13. A badge as set forth in claim 9, wherein one or more tie coats are provided between the backing sheet and the color coat.

14. A badge as set forth in claim 1, wherein the shaped laminate comprises a baseweb layer, a metal layer, and an optically clear polymeric outer layer.

15. A badge as set forth in claim 14, wherein the base-web layer comprises a flexible thermoplastic and thermoformable polyurethane film.

16. A badge as set forth in claim 14, wherein the metal layer comprises indium or an alloy of indium.

17. A badge as set forth in claim 14, wherein the metal layer is applied to the baseweb layer by vapor deposition techniques.

18. A badge as set forth in claim 14, wherein the optically clear polymeric outer layer contains an acrylic or polycarbonate resin.

19. A badge as set forth in claim 18, wherein the shaped laminate includes an over-laminate comprising a film of polyvinylidene fluoride and acrylic resin alloy bonded to the outer layer.

20. A badge as set forth in claim 14, wherein the outer layer is laminated to the exposed surface of the metalized film in free-film form and under heat and pressure.

21. A badge as set forth in claim 1, wherein the shaped laminate comprises a polymeric face sheet and an electrically conductive thermoformable polymeric primer coat bonded to an exterior surface of the polymeric face sheet.

22. A badge as set forth in claim 21, wherein the primer coat comprises a thermoplastically formable polymeric material containing a dispersed conductive material that provides electrical conductivity to an exposed surface thereof.

23. A badge as set forth in claim 22, wherein the primer coat is electrostatically painted.

24. A badge as set forth in claim 1, wherein the elastomer is a thermoplastic elastomer.

25. A badge as set forth in claim 1, wherein the thermoplastic elastomer is a thermoplastic polyolefin, thermoplastic urethane, polyurethane, polyester, polycarbonate, and/or a mixture of polycarbonate and ABS (acrylonitrile/butadiene-e/styrene).

26. A badge as set forth in claim 25, wherein the thermoplastic elastomer is urethane and includes fillers, catalysts, additives, and/or surfactants.

27. A badge as set forth in claim 1, wherein the elastomer is a gel-like organic material; a rubber-like organic material; a flexible, curable resin; and/or a flexible thermoplastic resin.

28. A badge as set forth in claim 27, wherein the elastomer is a gel-like organic material selected from a group consisting of silicone gels, acrylic resin gels, and/or fluorinated resin gels.

29. A badge as set forth in claim 27, wherein the elastomer is a rubber-like organic material selected from a group consisting of silicone rubbers, urethane rubbers, fluorinated rubbers, acrylic rubbers, ethylene-acrylic rubbers, SBR, BR, NBR, and/or chloroprene rubbers.

30. A badge as set forth in claim 27, wherein the elastomer is a flexible, curable resin selected from a group consisting of epoxy resins, ultraviolet-curing resins, and/or silicone resins.

31. A badge as set forth in claim 27, wherein the elastomer is a flexible thermoplastic resin selected from a group consisting of polyvinyl acetate, acrylic resins such as poly vinyl chloride, polyethyl methacrylate, polyvinylidene chloride resin, polyvinyl butyral resins and/or polyamide resins.

32. A method comprising the step of attaching the badge of claim 1 to an automobile.

33. A method as set forth in claim 32, further comprising the steps of placing an adhesive layer adjacent to the desired location on the automobile and applying pressure to secure the badge to the automobile.

34. A method as set forth in claim 33, further comprising the step of removing a release liner from the adhesive layer prior to said placing step.

35. In combination, an automobile and the badge of claim 1 attached to the automobile.

36. The combination set forth in claim 35, wherein the badge is attached to an exterior surface of the automobile.

37. The combination set forth in claim 35, wherein the badge is painted to match the color of the automobile.

38. A method of making the badge of claim 1, said method comprising the steps of:
providing a flat laminate;
three-dimensionally forming the flat laminate to form the shaped laminate;
pouring a pourable elastomer into the cavity; and
curing the poured elastomer to form the structural base.

39. A method of making a badge comprising a badge portion having a shaped laminate and a structural base, said method comprising the steps of:
providing a flat laminate;
three-dimensionally forming the flat laminate to form the shaped laminate so that it has an upper surface, providing the viewable surface of the badge portion, and a bottom surface, forming a cavity;
pouring a pourable elastomer into the cavity; and
curing the poured elastomer to form a structural base, which fills the cavity and which has a bottom surface at least partially forming the bottom surface of the badge portion.

40. A method as set forth in claim 39, wherein said forming step comprises thermoforming the flat laminate.

41. A method as set forth in claim 40, wherein the thermoforming step employs pressure, vacuum and/or mechanical forces.

42. A method as set forth in claim 40, wherein the laminate is heated to a temperature between about 250° and 480° F. during the forming step.

43. A method as set forth in claim 40, wherein the pouring step is performed by storing the elastomer in a suitable container at appropriate temperature and pressure conditions.

44. A method as set forth in claim 43, wherein the elastomer is mixed continuously or periodically to maintain the desired viscosity.

45. A method as set forth in claim 44, wherein the elastomer can be poured from the storage container.

46. A method as set forth in claim 40, wherein the curing step comprises traditional thermal curing, ultraviolet curing, and/or electron beam curing.
